(19) United States
(12) Patent Application Publication
(10) Pub. No.: US 2008/0029997 A1
(43) Pub. Date: Feb. 7, 2008

(54) Servodrive For A Trailer

(76) Inventors: Peter Wickelmaier, Munchen (DE); Hans-Georg Brunnhuber, Wangau (DE); Josef Brandtner, Germering (DE); Dieter Achatz, Munchen (DE); Jorg Muller, Kaufering (DE); Michael Fechner, Glonn (DE); Axel Schulz, Ampermoching (DE)

Correspondence Address: D. PETER HOCHBERG CO. L.P.A., 1940 EAST 6TH STREET, CLEVELAND, OH, 44114, US

(21) Appl. No.: 11/792,499

(22) PCT Filed: Dec. 5, 2005
(86) PCT No.: PCT/EP05/13024

§ 371 Date: Aug. 20, 2007

(30) Foreign Application Priority Data
Dec. 6, 2004 (DE) 10 2004 058 738.8

(51) Int. Cl. B60D 1/46

(52) U.S. Cl. 280/479.1

(57) ABSTRACT

An auxiliary drive for a trailer comprises a carrier that can be moved in relation to a chassis, said carrier holding a drive motor which can be used to drive a wheel of the trailer. The carrier can be swiveled from a drive position to a rest position and vice versa by means of an actuation lever. The moving mechanism provided for transmitting the movement of the manual actuation element comprises an energy storage or a servo-drive in order to prevent the operator from having to exert high operating forces.

### CROSS-REFERENCE TO RELATED APPLICATION

This application is a National Stage application of International Application No. PCT/EP2005/013024, filed on Dec. 5, 2005, which claims priority of German application No. 10 2004 058 738.8 filed on Dec. 6, 2004.

### BACKGROUND OF THE INVENTION

The invention relates to an auxiliary drive for a trailer, in particular for a travel trailer.

Usually, trailers are trailed by tractors. For example, it is known that passenger cars are able to trail a travel trailer. After it has been disconnected from the tractor, the trailer is usually pushed to its final position by hand. Today, however, the travel trailer industry increasingly offers trailers which, owing to their size and, therefore, to their weight, can be moved by hand with difficulty only. That is the reason why auxiliary drives permitting to move and/or turn a trailer with the support of a motor rather than with a tractor were developed.

An auxiliary drive for a trailer comprising a frame section which is connected to the chassis of the trailer in a non-detachable manner is disclosed in EP 0 827 898 A1. The frame section carries a carrier which is movable in relation to the frame section and, in turn, holds a drive motor comprising a drive roller drivable by the drive motor. Further, a moving mechanism is provided for moving the carrier from a rest position where the drive roller is separated from a tire of the trailer to a drive position where the drive roller is pressed against the tire of the carrier and vice versa. The change in position of the carrier is achieved manually by means of a lever which can be applied to the carrier.

Another auxiliary drive for a trailer, however operating on the same principle, is described in EP 1 203 713 A1. Whereas, however, the drive roller of the auxiliary drive according to EP 0 827 898 A1 is swiveled about a horizontal axis extending in parallel to the wheel axis, a vertical swivel axis is provided for the auxiliary drive according to EP 1 203 713 A1.

Typically, the carrier is swiveled from the rest position to the drive position in cooperation with a toggle mechanism which ensures that the carrier is locked in its particular end position, i.e. in its drive position or its rest position.

The carrier is swiveled by means of an actuation lever or a crank. Since high forces are necessary for overcoming the toggle mechanism, the swiveling angles required for an actuation lever are accordingly large. Nevertheless, it cannot be prevented that the particular end position of the carrier is reached only after the central position of the toggle mechanism has been overcome with much effort and, in the most cases, in a jerky manner. This is not only strenuous for the operator, but also gives rise to the risk that the operator squeezes his or her fingers. If the carrier is to be swiveled by means of a crank drive, the operator must actuate a crank which is, more often than not, poorly accessible, thus forcing him or her to assume a squat position. Due to the transmission ratio of crank drives, it is difficult for him or her to clearly distinguish the particular end positions. This gives rise to the risk that the compressive force required for pressing the drive roller against the tread of the trailer wheel to be driven by said drive roller will be inadequate and that the drive roller will spin when the attempt to move the trailer is made.

DE 35 32 993 A1 discloses a wheeled vehicle which is drivable by an electric motor through a driving wheel. The driving wheel is mounted to a carrier in bearings and can be moved from a drive position to a rest position and vice versa.

EP 1 447 312 A1 describes an auxiliary drive for a trailer comprising two motor-operated drive rollers which are held by a carrier. The carrier can be moved in relation to the chassis. To achieve this, a drive movement is transmitted via a lever system.

The invention aims at presenting an auxiliary drive for a trailer, which allows to conveniently move the carrier from its rest position to its drive position and vice versa, with the result that the operator is, in particular, protected from unfavorable postures or excessive efforts.

### SUMMARY OF THE INVENTION

According to the invention, this problem is solved by means of an auxiliary drive for a trailer according to anyone of Claims 1, 9, 14, and 15.

According to the variant of the invention presented in Claim 1, a moving mechanism is provided for moving the carrier from a rest position where the drive roller is separated from a wheel of the trailer to a drive position where the drive roller is pressed against the wheel of the trailer and vice versa. In analogy to the positions of the carrier, i.e. its rest position and its drive position, the moving mechanism comprises a movable manual actuation element, such as an actuation lever, the movement of which is transmitted to the carrier by said moving mechanism. According to the invention, the moving mechanism comprises an energy storage, wherein said energy storage can be charged during a first movement section of the manual actuation element, whereas the energy storage can be discharged during a second movement section of the manual actuation element to support the movement of the carrier. Therein, the second movement section is contained in the movement process that takes place while the manual actuation element is moved from its rest position to its drive position.

Therefore, the invention allows the operator to actuate the manual actuation element during the first movement section with a higher force than would be necessary for moving nothing but the carrier. Accordingly, the first movement section comprises at least one fraction of the movement range within which the carrier is still moved freely towards the tire or, without any hindering action of forces, away from the tire.

During the second movement section, however, the energy storage releases the energy stored therein, thus supporting the movement of the carrier, in particular whenever the carrier has to press the drive roller against the tread of the wheel. Likewise, the released energy can be used, for example, to reduce the maximum force required for overcoming the toggle effect.

In this manner, the invention permits to reduce the actuation force to be applied by the operator as compared with the peak forces that have, to date, particularly developed in association with toggle mechanisms. The operator does not have to move the operating lever across a certain range without any noticeable resistance any longer—as has been the case before—in order to subsequently overcome the toggle mechanism with great effort. On the contrary, he or she can move the operating lever (manual actuation element) from its rest position to its drive position with a uniform actuation force.

That is the reason why the second movement section, preferably, in part comprises at least a fraction of the movement which takes place while the drive roller is pressed against the tire. As a matter of course, the second movement section may also comprise other movement ranges, such as, in particular, the overcoming of a toggle mechanism.

In a particularly advantageous embodiment of the invention, the first movement section, that is the movement section where the energy storage is charged or—if it has already been precharged—is charged further, is contained in the movement process that takes place when the manual actuation element is moved from its drive position to its rest position. That means that the energy storage is charged whenever the carrier is moved away from the tire in order to reach its rest position. The energy is stored permanently and is again available when the reverse movement, that is the movement of the carrier from its rest position to its drive position, takes place.

In a further embodiment of the invention, the first movement section is contained in the movement process that takes place while the manual actuation element is moved from its rest position to its drive position, however prior to the second movement section, with the result that the manual actuation element, while it is moved from its rest position to its drive position, first passes through the first movement section and, thereafter, through the second movement section. In this variant, the movement of the manual actuation element is subdivided in two parts: at first, the manual actuation element must be moved with increased force in order to charge the energy storage. This is not problematic since the first movement section does not require any increased forces for overcoming the toggle mechanism or for pressing the drive roller against the tire yet. If, however, the increased operating force was demanded from the operator while he or she further moves the manual actuation element in presently known auxiliary drives, in order to overcome the toggle lever or to press the drive roller against the tire, the energy storage is now discharged according to the invention and produces a force which is superimposed on the operating force and, thereby, supports said operating force. Accordingly, the operator needs less force for pushing than with prior art auxiliary drives.

If the moving mechanism is designed appropriately, the operator can push and pull the manual actuation element with almost constant force over the entire movement path. Owing to the end positions of the manual actuation element, he or she receives information about the particular end position of the carrier. However, the operator does not receive any feedback that the toggle mechanism has been overcome or that the drive roller has been pressed against the tire, whenever the increased reaction forces that were hitherto developing are completely compensated by the energy storage.

Preferably, the energy storage comprises a spring assembly having, for example, a helical spring or a leaf spring, which allows storage of the energy in a simple manner without any significant losses, even over an extended period of time.

If the moving mechanism comprises a toggle mechanism, the toggle mechanism is, advantageously, movable against the action of the spring assembly. Therein, the spring assembly should, advantageously, act upon the knee of the toggle mechanism.

In a further embodiment of the invention, the moving mechanism comprises a movable cam disk which cooperates with the energy storage (the spring assembly) such that different cam disk positions lead to different charge conditions of the energy storage (spring deflection). As a result, the cam disk can be used to tension the spring during the first movement section and—if designed accordingly—to relax the spring during the second movement section, so that the spring supports a corresponding rotation of the cam disk.

A variant of the invention is defined in Claim 9. Therein, the moving mechanism comprises a transmission mechanism having a transmission effect that can be changed through the movement path of the manual actuation element such that a specific movement path of the manual actuation element causes movement paths of the carrier that are different in length, depending on whether the manual actuation element and the carrier are located closer to the rest position or closer to the drive position.

According to the invention, the transmission mechanism enables the “transmission ratio” between the movement of the manual actuation element and the movement of the carrier to be changed. If the movement path (pushing or swiveling) of the manual actuation element has the same length, it causes, in this manner, movement paths of different lengths, depending on the region in which this movement path of the manual actuation element takes place.

The movement path of the manual actuation element is to particular advantage if it causes a movement path of the carrier that is longer in the vicinity of the rest position than in the vicinity of the drive position. That means that, in the rest position, the carrier must, usually, only be pushed, wherein the actuation force only has to overcome the unavoidable friction. In the vicinity of the drive position, however, the manual actuation force must not only press the drive roller against the tread of the tire to an adequate extent but it must, for example, also overcome a toggle mechanism. Since the transmission mechanism allows different transmission effects, i.e. different transmission ratios or leverages, a short movement of the manual actuation element may already be sufficient to achieve a corresponding movement of the carrier, when it takes place in the vicinity of the rest position, that is in the region where high forces are not required for moving the carrier. In the vicinity of the drive position, however, the carrier, in order to make the actuation force uniform for the operator, should be aimed at making a smaller, particularly shorter movement with a correspondingly equal movement path of the manual actuation element, thereby reducing the forces retroacting on the manual actuation element.

In a particularly advantageous embodiment of the invention, a first transmission ratio between the movement of the manual actuation element and the movement of the carrier is formed in the first movement section while the manual actuation element is moved from its rest position to its drive position, this being achieved such that a specific movement path of the manual actuation element causes a first movement path of the carrier wherein, in a second movement section, a second transmission ratio between the movement of the manual actuation element and the movement of the carrier is formed such that the specific movement path of the manual actuation element causes a second movement path of the carrier. This definition confirms the aforementioned statements according to which different movement paths of the carrier are achieved with equal movement paths of the manual actuation element (although starting from different initial positions).

Therein it is to advantage that the second movement section comprises, at least in part, that part of the movement in which the drive roller is pressed against the tire and that the second movement path of the carrier is shorter than the first movement path of the carrier.

In order to achieve the desired change in the transmission ratio of the movement, it is to particular advantage if the transmission mechanism comprises a curved guide, for example in the form of an eccentric or a coulisse.

In further variants of the invention, which are defined in Claims 14 and 15, the auxiliary drive is not equipped with a manual actuation element. Rather, the moving mechanism comprises a servo-drive for moving the carrier from its rest position to its drive position and vice versa.

Owing to the servo-drive, manual actuation is not necessary any longer. Using the servo-drive which may, for example, be remote-controlled, the operator can move the carrier to the particular position desired.

Preferably, the servo-drive comprises an electric, electrohydraulic, electromagnetic, hydraulic, hydro-pneumatic or pneumatic control element. Energy supply can be assumed by a battery available in the trailer or by a separate power supply source. Therein, it is, for example, possible to operate the pneumatic control element by means of an electric camping air pump which is, otherwise, used for different purposes. The electrically operated air pump will only be actuated for activating the pneumatic control element when the operator needs the auxiliary drive.

It is also possible to use a hydraulic motor as a hydraulic control element, said hydraulic motor receiving a pressurized hydraulic fluid from an appropriate pump.

The servo-drive is to particular advantage if it comprises an electric auxiliary motor, preferably having a gear.

In order to allow the auxiliary motor to be dimensioned accordingly small, it is to advantage if the gear comprises a spindle drive with a high transmission ratio. The spindle drive allows the motor to operate at relatively high speeds but low torque and, thus, to be dimensioned relatively small.

In a particularly advantageous embodiment of the invention, the chassis of the trailer comprises at least two wheels, wherein a separate drive motor and a separate drive roller are allocated to each wheel. Therein, it is to advantage if the servo-drive comprises only one common auxiliary motor which can be used to simultaneously move the two drive motors and the two drive rollers, that is both carriers, from their rest position to their drive position and vice versa. In this case, the auxiliary motor is, preferably, arranged midway between the two wheels.

The direction of movement of the carrier can be varied as desired. It is to particular advantage if the carrier can, in essence, be moved radially and/or linearly in relation to the tire of the trailer.

Therein, the drive roller can be swiveled towards the tread of the tire. Therein, it can, advantageously, be swiveled in a swivel plane which is either extending perpendicularly to a rotational axis or comprises the rotational axis itself or is extending at an angle in relation to a plane comprising the rotational axis.

It is to further advantage if a locking assembly is provided for locking the carrier relative to the frame section at least in the drive position. This ensures that the drive roller is pressed against the tread of the tire with the necessary compressive force.

This and further advantageous features of the invention will be illustrated below by means of the accompanying figures.

### BRIEF DESCRIPTION OF THE DRAWINGS

FIG. 1 shows an exemplary torque curve for illustrating the invention;

FIG. 2 is a schematic diagram of a first embodiment of the invention, comprising an auxiliary drive in an intermediate position between the rest position and the drive position;

FIG. 3 shows the auxiliary drive of FIG. 2 in its drive position;

FIG. 4 shows a torque graph for illustrating the auxiliary drive of FIGS. 2 and 3;

FIG. 5 is a schematic representation of an auxiliary drive according to the invention in a second embodiment;

FIG. 6 is a schematic representation of the auxiliary drive according to the invention in a third embodiment;

FIG. 7 shows a torque curve for illustrating the auxiliary drive of FIG. 6;

FIG. 8 is a schematic diagram showing the design of an auxiliary drive according to the invention in a forth embodiment;

FIG. 9 shows an enlarged detail of the auxiliary drive of FIG. 8;

FIG. 10 is a schematic diagram showing the design of an auxiliary drive according to the invention in a fifth embodiment;

FIG. 11 is a schematic diagram showing the design of an auxiliary drive according to the invention in a sixth embodiment; and

FIG. 12 shows an enlarged detail of FIG. 11.

### DETAILED DESCRIPTION OF THE PREFERRED EMBODIMENTS

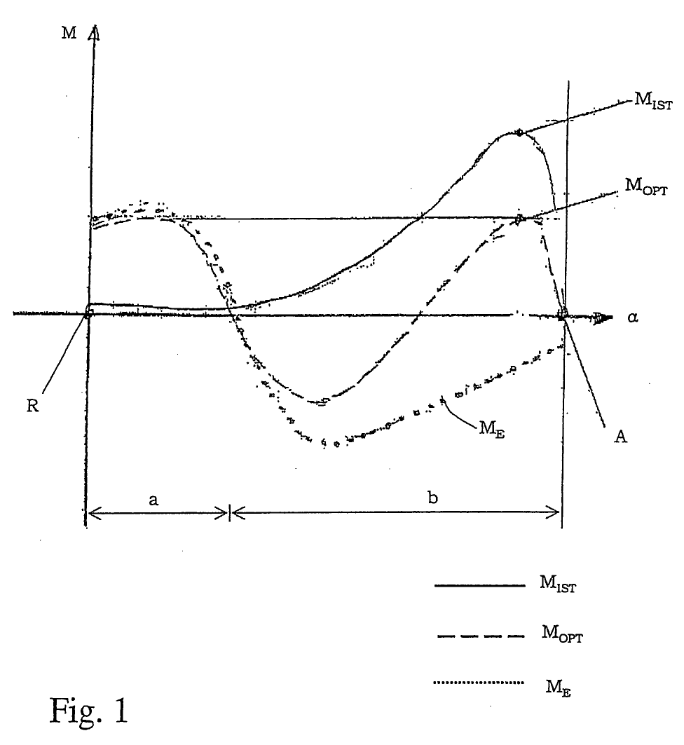

FIG. 1 shows a multitude of torque curves for illustrating a first operating principle forming the basis of the invention.

The figure shows the curves of torques acting upon a manual actuation element, e.g. an actuation lever, in relation to the swiveling angle α thereof. The actuation lever can be swiveled between a rest position R (swiveling angle α=0) and a drive position A (swiveling angle α=max) and vice versa in known manner.

M_{IST} shows the torque curve that usually acts upon the actuation lever while the operator swivels the lever from its rest position R to its drive position A as a continuous line. Therein, the operator initially has to exert only low forces because the torque required is low as well. Shortly before the drive position A, however, the necessary torque M_{IST} rises significantly, on the one hand to overcome, for example, the central or zero position of a toggle mechanism and, on the other hand, to generate a sufficient compressive force to press the drive roller against the wheel of the trailer. After having overcome the maximum, the torque drops to zero because the actuation lever stops in its end position (drive position A).

According to the invention, an energy storage which is charged in a first movement section a by swiveling the actuation lever is now also associated with the actuation lever. That is the reason why the first movement section a represents a specific swiveling angle α which is positioned in the vicinity of the rest position R. This is followed by a second movement section b, in which the energy storage is discharged again, thus supporting the further rotary movement of the actuation lever.

The torque acting through the energy storage is represented as a dotted line M_{E}. In the first movement section, M_{E} is positive with the result that the energy storage is charged whereas, in the second movement section b, the torque curve M_{E} is in the negative range with the result that the energy storage itself contributes to the torque action and supports the movement of the actuation lever.

Superimposing the torque M_{E} acting through the energy storage on the torque M_{IST} required for pressing the pressing roller results in the optimized torque curve M_{OPT} which is represented as a dashed line in FIG. 1. As can be seen, the operator must apply an increased torque during the first movement section a, contrary to moving mechanisms without any energy storage. This charges the energy storage. In a first part of the second movement section, the curve M_{OPT} is in the negative range, i.e. the effect of the energy storage is so strong that the drive roller is almost automatically moved towards the tire. The operator rather has to firmly hold the operating lever to prevent it from slipping out of his or her hand.

In the following second part of the second movement section b, the torque M_{OPT} returns to the positive range, with the result that the operator can easily move the operating lever to the drive position.

As can be clearly seen from FIG. 1, the amount-related values of the optimized torque curve M_{OPT} is always distinctly below the hitherto necessary maximum torque value of curve M_{IST}. Owing to the effect of the energy storage, the operator can accordingly move the auxiliary drive with less comparative operating forces.

FIG. 1 only shows exemplary torque curves for illustrating the principle. As a matter of course, it is also possible to achieve other torque curves, depending on the design of the energy storage and the moving mechanism. For example, the optimized torque M_{OPT} may be aimed at never becoming negative, with the result that the operator always has to push the operating lever in one direction only, not having to hold it in the opposite direction. Further, it is a matter of course that the energy content of the energy storage must be equal during charging and discharging—with potential friction losses being neglected—this not being fully expressed in FIG. 1. In addition, a bias of the energy storage must be taken into consideration.

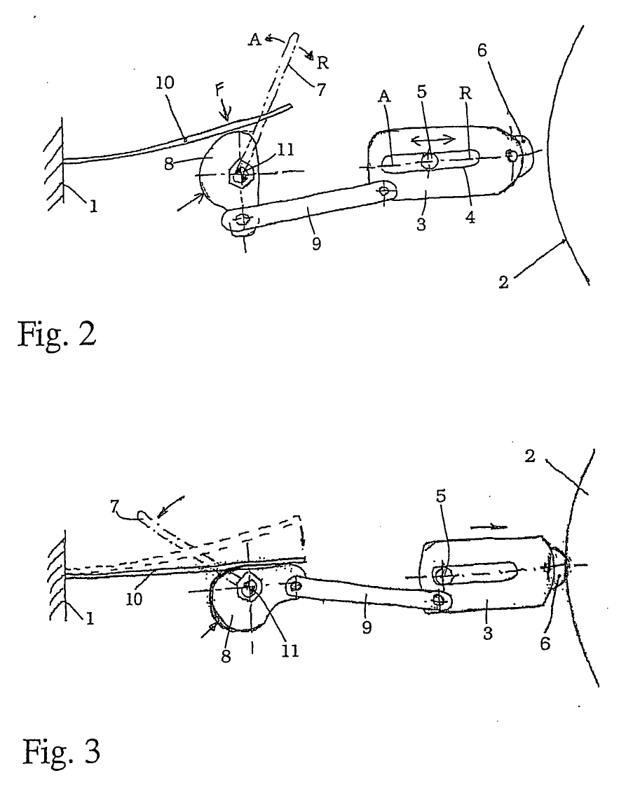

The principle illustrated by means of FIG. 1 will now be illustrated in more detail by means of embodiments represented in FIGS. 2 to 5.

FIG. 2 is a schematic diagram of an auxiliary drive for a trailer according to the invention. The trailer comprises a chassis 1 which is usually supported by one or two wheel axles. Wheels are attached to the wheel axles in known manner, wherein a tire of a wheel 2 is represented in FIG. 2 in fragmentary form.

The auxiliary drive comprises a frame section rigidly connected to the chassis 1 wherein, as a matter of course, the frame section may also be the chassis 1 itself. The only decisive factor is that the auxiliary drive can be supported against the chassis 1 and that, accordingly, there is a rigid connection to the chassis 1.

A carrier 3 is held in a movable manner in relation to the frame section/chassis 1. In the illustrated instance, the carrier only comprises an elongated hole 4 sliding over a pin 5. The pin 5 is rigidly connected to the chassis 1 and, thus, holds the carrier 3.

The carrier 3 rotatably holds a drive roller 6 which is, in turn, driven by a drive motor which is not shown here. In order to initiate a rotary movement of the drive roller 6, the drive motor can, for example, be activated and deactivated through remote control or appropriate cabling.

The exemplary embodiment of FIG. 2 is only shown schematically. Together with the drive motor and the drive roller, the carrier 3 can also be designed in the manner described, for example, in EP 0 827 898 A1 or in EP 1 203 713 B1. FIG. 2 is only intended to illustrate the operating principle.

According to the diagram shown in FIG. 2, the drive roller 6 is separated from the wheel 2. The drive roller 6, together with the carrier 3, is in an intermediate position between the rest position and the drive position.

For comparative purposes, FIG. 3 shows the same auxiliary drive, however in the drive position where the drive roller 6 is pressed against the wheel 2.

The position of the carrier 3 with the drive roller 6 and the drive motor (not shown) is changed by means of an operating lever 7 serving as a manual actuation element. The operating lever 7 can be moved from the intermediate position shown in FIG. 2 to the drive position shown in FIG. 3 or to a rest position which is not shown here. While the carrier 3 is in the drive position, the pin 5 is positioned at position A in the elongated hole 4, whereas the pin 5 is positioned at position R while the carrier 3 is in the rest position, as can be seen from FIG. 2.

The actuation lever 7 is an integral part of a moving mechanism which, furthermore, comprises a cam disk 8 coupled to the lever, a push rod 9 and a leaf spring 10 serving as an energy storage. The actuation lever 7 can be swiveled about an axis 11 together with the cam disk 8.

As can be seen from the comparison of FIGS. 2 and 3, the appropriate outer contour of the cam disk 8 causes the leaf spring to be deflected in the intermediate position shown in FIG. 2 and also in a corresponding rest position R, whereas it is relaxed to a greater extent in the drive position A shown in FIG. 3. Accordingly, the outer contour of the cam disk 8 comprises a circle segment region arranged concentrically with the axis 11 as well as a flattened region where the leaf spring 10 enters the drive position shown in FIG. 3.

By appropriately selecting the position of the leaf spring 10 relative to the axis 11 and designing the point of action of forces between the leaf spring 10 and the cam disk 8, a torque is enabled to be transmitted between the cam disk 8 and the leaf spring 10. In particular, the leaf spring 10 can exert a force on the cam disk 8 the vector of which does not intersect the axis 11. Accordingly, the leaf spring 10 generates a torque about the axis 11.

In the drive position A shown in FIG. 3, the leaf spring 10 is more relaxed as compared with the rest position R shown in FIG. 2 and, therefore, stores less energy. When the carrier 3 is pulled back by swiveling the actuation lever 7, however, the leaf spring 10, due to the shape of the cam disk 8, is deflected to a greater extent and assumes the position shown in FIG. 2. By being deformed, the leaf spring 10 stores energy. Accordingly, the operator has to apply an increased force to the actuation lever 7 to generate the torque required. The energy remains stored in the leaf spring 10 until the operator swivels the actuation lever 7 in the opposite direction to move the carrier 3 to the drive position. Then, the leaf spring 10 releases the stored energy and generates on the cam disk 8 a torque which is converted into a force supporting the movement of the carrier 3, with the result that the force the operator has to apply to the actuation lever 7 is decreased.

Depending on the embodiment, it may also be appropriate to provide the cam disk 8 with a helical outer contour, in order to remove the point of action of forces between the leaf spring 10 and the cam disk 8 with regard to its distance and its position from the axis 11 and to achieve a change in the acting torque.

As has already been mentioned, the carrier 3 can also be moved in any other manner desired, either by means of a linear guide or about a swivel axis (arranged vertically or horizontally). However, this is of no consequence for the invention. It is, for example, no problem if the carrier 3 shown in FIGS. 2 and 3 is swiveled about a stationary vertical or horizontal axis by means of the push rod 9 rather than in a linear manner along the pin 5.

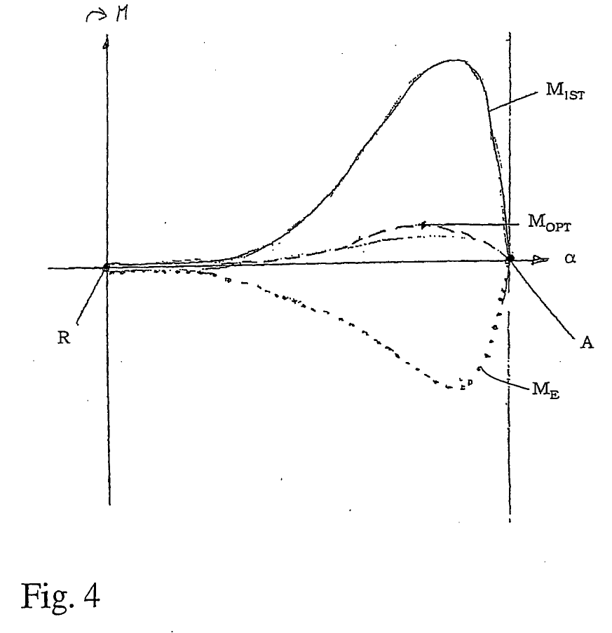

In a manner analogous to FIG. 1, FIG. 4 shows the torque curve wherein the continuous line represents the torque M_{IST} which would develop if the moving mechanism did not comprise any energy storage in the form of the leaf spring 10. The dotted line M_{E} shows the torque resulting from the energy stored in the leaf spring 10, whereas M_{OPT} represents the torque the operator has to apply manually to the actuation lever 7. As a matter of course, FIG. 4 is only an exemplary qualitative illustration like FIG. 1.

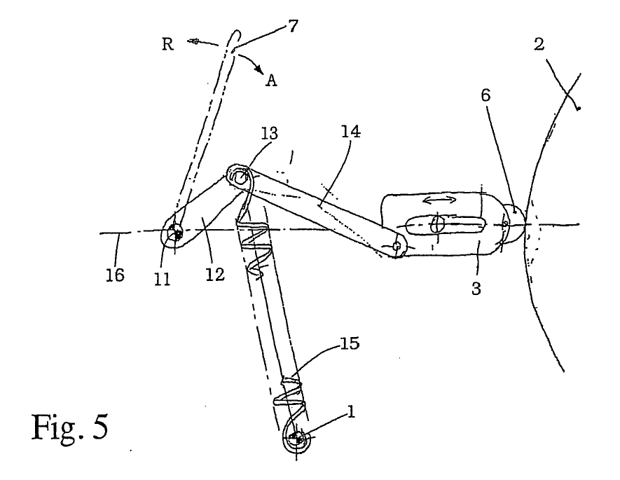

FIG. 5 shows a second embodiment of the invention, according to which the carrier 3 with the drive roller 2 essentially corresponds to the carrier 3 described in connection with FIGS. 2 and 3.

The moving mechanism used in the second embodiment also comprises the actuation lever 7 that can be swiveled about the axis 11. A first link 12 which is connected to a second link 14 through a toggle joint 13 is connected to the actuation lever 7 in a non-removable manner. The second link 14 is then directed to the carrier 3 and moves it in the manner required.

A helical spring 15 which serves as an energy storage and is supported against the chassis 1 acts on the toggle joint 13.

In the diagram shown in FIG. 5, the drive roller 6 is positioned shortly before its drive position A, but does not touch the tread of the tire 2 yet. On the contrary, the actuation lever 7 would have to be pressed further in the direction of the arrow A, so that the toggle joint 13 is bent beyond its zero position (the angle between the first link 12 and the second link 14 is 180 degrees; dead-center position of toggle). Only when the toggle joint 13 is positioned below a reference line 16 will the drive roller 6 reach its drive position. As a matter of course, the toggle joint 13 must be prevented from being bent further by means of an appropriate stop. The dead-center position of the toggle having the spring 15, thus, also serves to ensure reliable detection of the end position (rest position).

The movement of the toggle joint 13 beyond the reference line 16 is supported by the biased helical spring 15. This enables the operator to bend the toggle joint 13 through its zero position, but also to simultaneously provide the compressive force required for pressing the drive roller 6 against the tire 2.

When the actuation lever 7 is swiveled back to move the carrier 3 to its rest position R, however, the helical spring 15 is tensioned so that it can store the necessary energy in this manner. The helical spring 15 is able to retain the energy over an extended period of time (days, months) and release it again only where required.

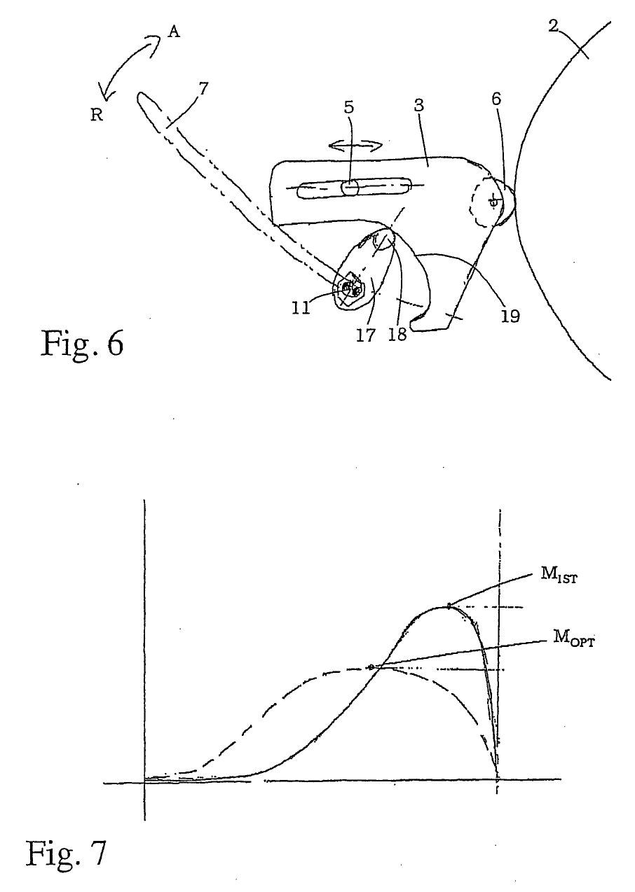

FIG. 6 shows a third embodiment of the invention where the moving mechanism comprises in the stead of an energy storage a transmission mechanism the transmission effect of which can be changed in relation to the swivel position of the operating lever serving as a manual actuation element.

For this purpose, a guide element 17 which can also be swiveled about the axis 11 is connected to the actuation lever 7 in a non-removable manner.

Preferably, the guide element 17 carries a pulley 18 which can be moved along a curved guide 19 connected to the carrier 3. It is also possible to select a closed coulisse in the stead of the curved guide 19.

While the actuation lever 7 is swiveled to the drive position A, the guide element 17 is also swiveled, with the result that the pulley 18 presses against the curved guide 19 and, thereby, presses the carrier 3 together with the drive roller 6 against the tire 2.

Provided the curved guide 19 is designed as a coulisse, the pulley 18 also pulls back the carrier 3 while the actuation lever 7 is swiveled back to its rest position R, so that the drive roller 6 is separated from the tire 2. Alternatively, the carrier 3 can also be pulled back from its drive position to its rest position by means of a spring assembly.

As a matter of course, it is easily possible to replace the shown pulley 18 and the curved guide 19 by cams or eccentrics to achieve similar effects.

It is to particular advantage if the curved guide 19 comprises different radiuses of curvature. As a result, a relative swift movement of the carrier 3 can be achieved in a first movement section where the operator does not have to exert high forces yet whereas, in the range where the operator normally would have to exert a high operating force and owing to the design of the curved guide 19, longer swivel paths of the actuation lever 7 only cause shorter push or swivel paths of the carrier 3. In this manner, the transmission effect or the transmission ratio of the moving mechanism can be changed while the actuation lever 7 is swiveled—in relation to the latter's absolute position.

FIG. 7 shows the associated torque curves wherein M_{IST} again represents the torque that would develop if the moving mechanism were not designed in the manner according to the invention, whereas M_{OPT}, represented by the dashed line, shows the improved, i.e. comparative torque curve. As can be seen, the maximum torque for M_{OPT} is clearly lower than the hitherto developing maximum torque of the curve M_{IST}.

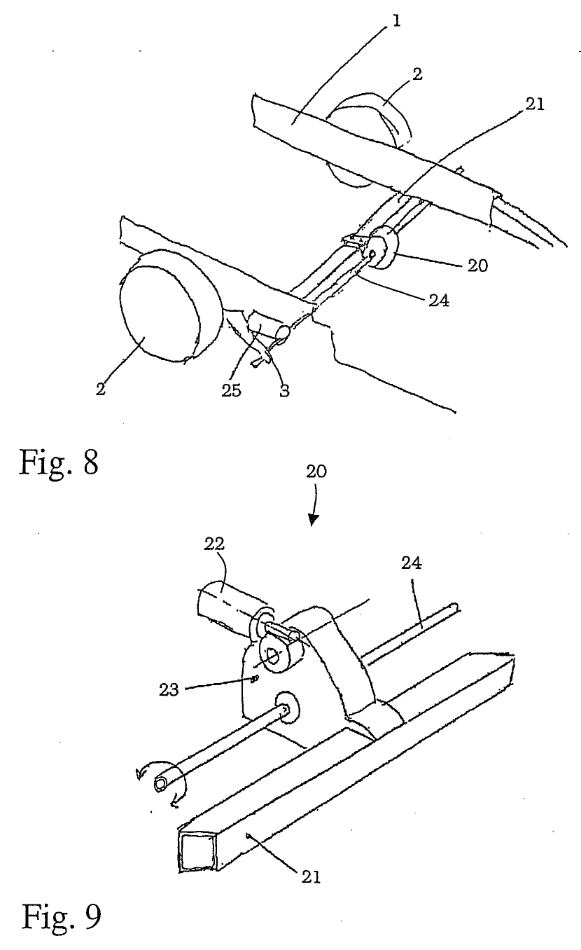

FIGS. 8 and 9 show a forth embodiment of the invention, wherein FIG. 9 shows an enlarged detail of FIG. 8.

Two wheels each carrying a wheel 2 are held on the chassis 1.

A servo-drive 20 is arranged between the wheels 2, said servo-drive 20 being held by a cross member 21 also serving as a torque support.

As shown in FIG. 9, the servo-drive 20 comprises an electric auxiliary motor 22 which rotatably drives a swivel rod 24 via a gear 23. The auxiliary motor 22 and the gear 23 may form a motor-gear unit. The direction of rotation of the auxiliary motor 22 can be reversed, so that the swivel rod 24 can be turned in either direction.

On either of its sides, the swivel rod 24 is guided outwards to the wheels 2 so that, there, the particularly allocated carrier 3 can be swiveled from its rest position to its drive position and vice versa. The swivel rod 24 can be attached in parallel with the cross member 1, but also inside the cross member 21.

In the stead of the servo-drive 20 which is arranged approximately midway between the two wheels 2, it is also possible to provide a servo-drive 25 which is attached to one side of the chassis 1 only and the rotary movement of which is nevertheless also transmitted to the opposite carrier 3 of the other wheel 2 through the swivel rod 24. It is likewise possible to allocate a single servo-drive 25 to each carrier 3 to swivel the carrier 3 from its rest position to its drive position and vice versa.

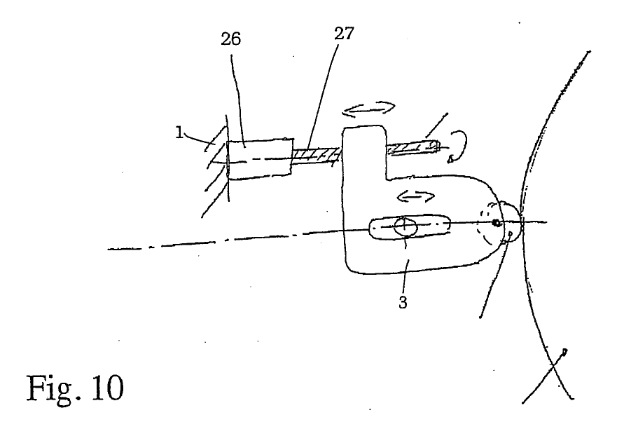

FIG. 10 shows, as a variant, a fifth embodiment of the invention where the servo-drive is formed by a motor-gear unit 26 which is held on the chassis 1 and rotatably drives a spindle 27. The carrier 3 is moved to and fro linearly between its rest position and its drive position by means of said spindle 27.

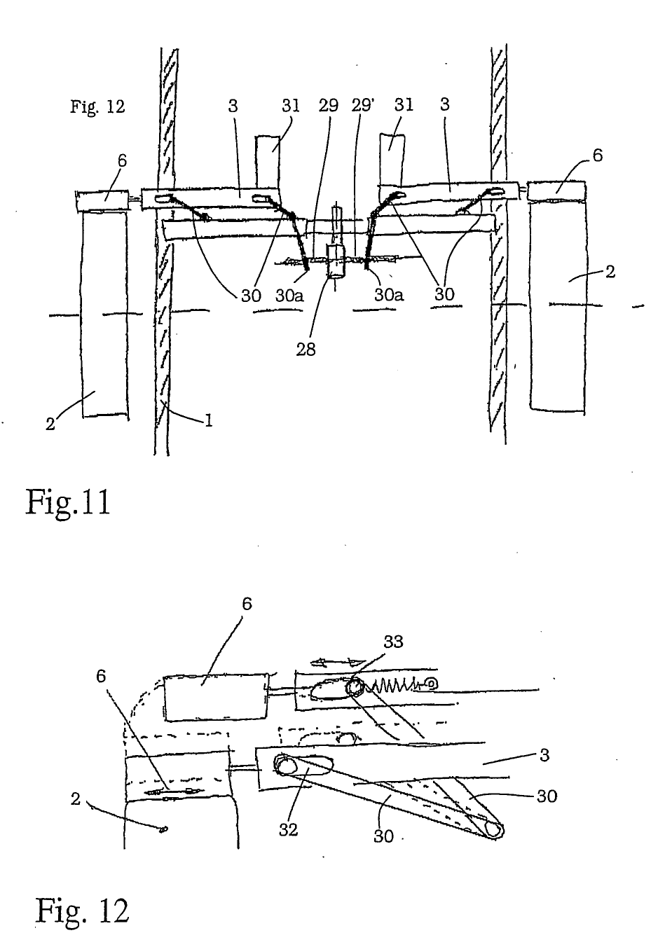

A sixth embodiment of the invention is shown in FIG. 11 and, in an enlarged detail, in FIG. 12.

Formed as motor-gear unit, a servo-drive 28 held or supported against the chassis 1 drives swivel spindles 29 and 29′ extending in either direction. The spindles 29, 29′ are each connected to a carrier 3 through a lever 30a and through a parallel guide 30, wherein said carrier 3 can accordingly be moved in parallel in relation to the chassis 1 by means of the parallel guide 30. A drive motor 31 is also provided on each of the carriers 3. The servo-drive 28 rotates the swivel spindles 29 and 29′ on which the levers 30a move in accordingly guided manner. As a result, the carriers 3 are each shifted outwards in parallel, provided the spindles 29, 29′ are rotating in the appropriate direction of rotation.

The parallel shifting of the carrier 3 causes the drive roller 6 to be pressed against the wheel 2. Owing to the symmetrical design, the movement of the two carriers 3 is effected simultaneously. When the rotary movement of the servo-drive 28 is reversed, the swivel spindles 29, 29′ simultaneously pull the carriers 3 inwards in parallel, so that the carriers can reach their rest position.

Once the drive roller 6 has reached the tread of the wheel 2, it must be further pressed against the wheel 2 in order that an appropriate friction effect can be achieved. Due to the parallel guide 30, however, the drive roller 6 is moved not only radially in relation to the wheel 2, but also axially, thus causing in the contact surface between the drive roller 6 and the tread of the wheel 2 the development of a grinding effect which might damage the tread.

To prevent this grinding effect, an elongated hole 32 engaging the parallel guide 30 is formed in the carrier 3. As shown in FIG. 12, a pin 33 pertaining to the parallel guide 30 is initially positioned in a rear region of the elongated hole 32. Once the drive roller 6 has reached the tread of the wheel 2 so that it cannot be moved radially towards the wheel 2 by a significant distance any longer, the carrier 3, on further movement, is shifted along the pin 33 in relation to the parallel guide 30, as indicated by the appropriate intermediate positions in FIG. 12. Therein, there is no axial shift of the carrier 3 along with the drive roller 6 any longer. On the contrary, the carrier 3 and the drive roller 6 are only pulled radially towards the wheel 2 until they have reached their drive position.

To date, only electric auxiliary motors have been described as servo-drives. In the variants of the invention, which are not presented in the figures, however, servo-drives are provided where the necessary movement of the carrier is achieved by means of a control element. Therein, electric, electrohydraulic, electromagnetic, hydraulic, hydro-pneumatic or pneumatic control elements are suitable. For example, a pneumatic control element can be operated through a usual camping compressor which is, otherwise, used for inflating air mattresses. The compressor needs to be connected to the pneumatic control element only when the position of the carrier 3 must be changed.

Furthermore, it is appropriate to provide a locking assembly which can be used to reliably maintain at least the drive position of the carrier, but also preferably the rest position of the carrier. Latches, stop assemblies or toggle mechanisms, as they are, for example, known from EP 0 827 898 A1, can be used as locking assemblies.

As has already been described above, the invention allows the carrier to be moved from the rest position to the drive position and vice versa in almost any manner desired. Apart from a linear movement, the carrier can also be swiveled about axes arranged as desired, either in lateral or radial or axial direction. In this manner, the carrier can be parked in its rest position in a protected region below or inside the chassis where it is accommodated safely and where it cannot be damaged while the trailer is moved with a tractor in the normal manner. As a matter of course, it is also possible to combine various forms of movement, such as swiveling or linear shifting, in order to achieve the desired movement path of the carrier.

Having described preferred methods of putting the invention into effect, it will be apparent to those skilled in the art to which this invention relates, that modifications and amendments to various features and items can be effected and yet still come within the general concept of the invention. It is to be understood that all such modifications and amendments are intended to be included within the scope of the present invention.

1. An auxiliary drive for a trailer, comprising:
a frame section rigidly connected to a chassis of the trailer;
a carrier movable in relation to the frame section;
a drive motor held by the carrier;
a drive roller mounted to the carrier in bearings and drivable by the drive motor; and comprising:
a moving mechanism for moving the carrier from a rest position where the drive roller is separated from a wheel of the trailer to a drive position where the drive roller is pressed against the wheel of the trailer and vice versa;
wherein the moving mechanism comprises a manual actuation element movable in analogy with the positions of the carrier from a rest position to a drive position and vice versa and the movement of which is transmitted to the carrier through the moving mechanism;
wherein the moving mechanism comprises an energy storage and at least one toggle mechanism;
the energy storage can be charged during a first movement section of the manual actuation element;
the toggle mechanism can be overcome during a second movement section of the manual actuation element and, at the same time, the energy storage can be discharged, in order to support the movement of the carrier and to overcome the toggle effect, and wherein
the second movement section is contained in the movement process that takes place while the manual actuation element is moved from its rest position to its drive position.

2. The auxiliary drive according to claim 1, wherein the second movement section, at least in part, comprises a fraction of the movement which takes place while the drive roller is pressed against the wheel.

3. The auxiliary drive according to claim 1, wherein the first movement section is contained in the movement process that takes place while the manual actuation element is moved from the drive position to the rest position.

4. The auxiliary drive according to claim 1, wherein the first movement section is contained in the movement process that takes place while the manual actuation element is moved from its rest position to its drive position, however prior to the second movement section, the manual actuation element, while said manual actuation element moves from its rest position to its drive position, first passes through the first movement section and, thereafter, through the second movement section.

5. The auxiliary drive according claim 1, wherein the energy storage comprises a spring assembly.

6. The auxiliary drive according to claim 5, wherein the moving mechanism comprises a movable cam disk which cooperates with the energy storage such that different cam disk positions lead to different charge conditions of the energy storage.

7. The auxiliary drive according to claim 1, wherein the toggle mechanism is movable against the action of a spring acting on the toggle of the toggle mechanism.

8. An auxiliary drive for a trailer, comprising:
a frame section rigidly connected to a chassis of the trailer;
a carrier movable in relation to the frame section;
a drive motor held by the carrier;
a drive roller mounted to the carrier in bearings and drivable by the drive motor; and comprising:
a moving mechanism for moving the carrier from a rest position where the drive roller is separated from a wheel of the trailer to a drive position where the drive roller is pressed against the wheel of the trailer and vice versa;
wherein the moving mechanism comprises a manual actuation element movable in analogy with the positions of the carrier from a rest position to a drive position and vice versa and the movement of which is transmitted to the carrier through the moving mechanism; wherein
the moving mechanism comprises a transmission mechanism having a transmission effect that can be changed through the movement path of the manual actuation element such that a specific movement path of the manual actuation element causes movement paths of the carrier that are different in length, depending on whether the manual actuation element and the carrier are located closer to the rest position or closer to the drive position; and
an equally long movement path of the manual actuation element causes a movement path of the carrier that is longer in the vicinity of the rest position than in the vicinity of the drive position.

9. The auxiliary drive according to claim 8, wherein a first transmission ratio between the movement of the manual actuation element and the movement of the carrier is formed in a first movement section while the manual actuation element is moved from its rest position to its drive position, this being achieved such that a specific movement path of the manual actuation element causes a first movement path of the carrier and that, in a second movement section, a second transmission ratio between the movement of the manual actuation element and the movement of the carrier is formed such that the specific movement path of the manual actuation element causes a second movement path of the carrier.

10. The auxiliary drive according to claim 9, wherein the second movement section, at least in part, comprises that part of the movement that takes place while the drive roller is pressed against the wheel.

11. The auxiliary drive according to claim 9, wherein the second movement path of the carrier is shorter than the first movement path of the carrier.

12. The auxiliary drive according to claim 8, wherein the transmission mechanism comprises a curved guide.

13. The auxiliary drive according to claim 12, wherein the curved guide comprises an eccentric.

14. An auxiliary drive for a trailer, comprising:
a frame section rigidly connected to a chassis of the trailer;
a carrier movable in relation to the frame section, and a spindle directly coupled to said carrier;
a drive motor held by the carrier;
a drive roller mounted to the carrier in bearings and drivable by the drive motor; and comprising:
a moving mechanism for moving the carrier from a rest position where the drive roller is separated from a wheel of the trailer to a drive position where the drive roller is pressed against the wheel of the trailer and vice versa;
wherein the moving mechanism comprises a servo-drive for moving the carrier from its rest position to its drive position and vice versa;
wherein the servo-drive rotatably drives said spindle directly coupled to the carrier, such that the carrier can be moved linearly in relation to the rotation of the spindle (27) from its rest position to its drive position and vice versa.

15. An auxiliary drive for a trailer, comprising:
a frame section rigidly connected to a chassis of the trailer;
a carrier movable in relation to the frame section;
a drive motor held by the carrier;
a drive roller mounted to the carrier in bearings and drivable by the drive motor; and comprising:
a moving mechanism for moving the carrier from a rest position where the drive roller is separated from a wheel of the trailer to a drive position where the drive roller is pressed against the wheel of the trailer and vice versa;
wherein the moving mechanism comprises a servo-drive for moving the carrier from its rest position to its drive position and vice versa;
and wherein a swivel rod for swiveling the carrier from its rest position to its drive position and vice versa is arranged between the servo-drive and the carrier.

16. The auxiliary drive according to claim 14, wherein the servo-drive comprises a control element selected from the group consisting of an electric control element, an electrohydraulic control element, an electromagnetic control element, a hydraulic control element, a hydro-pneumatic control element or a pneumatic control element.

17. The auxiliary drive according to claim 14, wherein the servo-drive comprises an electric auxiliary motor having a gear.

18. The auxiliary drive according to claim 17, wherein the gear comprises a spindle drive.

19. The auxiliary drive according to claim 14, wherein a parallel guide holds the carrier.

20. The auxiliary drive according to claim 19, wherein the spindle drive actuates the parallel guide for moving the carrier (3).

21. The auxiliary drive according to claim 20, wherein a pivot point of the parallel guide on the carrier can be moved to a limited extent in relation to the carrier.

22. The auxiliary drive according to claim 14, wherein the chassis carries at least two wheels; and
a separate drive motor and a separate drive roller are allocated to each wheel.

23. The auxiliary drive according claim 22, wherein the servo-drive comprises an auxiliary motor for simultaneously moving the two drive motors and the two drive rollers.

24. The auxiliary drive according to claim 23, wherein the auxiliary motor is arranged midway between the at least two wheels.

25. The auxiliary drive according to claim 1, wherein the carrier is movable radially in relation to the wheel of the trailer.

26. The auxiliary drive according claim 1, wherein the carrier can be moved is movable linearly.

27. The auxiliary drive according claim 1, wherein the drive roller is swivelable to the tread of the wheel.

28. The auxiliary drive according to claim 1, wherein the drive roller is swivelable to the tread of the wheel in a swivel plane, wherein said swivel plane:
extends perpendicularly to a rotational axis of the wheel (2);
comprises the rotational axis; or
extends at an angle in relation to a plane comprising the rotational axis.

29. The auxiliary drive according to claim 1, wherein a locking assembly is provided for locking the carrier in relation to the frame section at least in the drive position.
